(19) United States
(12) Patent Application Publication
(10) Pub. No.: US 2007/0245411 A1
(43) Pub. Date: Oct. 18, 2007

(54) Methods, systems and computer program products for single sign on authentication

(76) Inventor: Gregory Newton, Dunwoody, GA (US)

Correspondence Address: MYERS BIGEL SIBLEY & SAJOVEC, P.A., P.O. BOX 37428, RALEIGH, NC, 27627, US

(21) Appl. No.: 11/316,426

(22) Filed: Dec. 22, 2005

Related U.S. Application Data
(60) Provisional application No. 60/717,272, filed on Sep. 15, 2005.

(51) Int. Cl. G06F 17/30

(52) U.S. Cl. 726/8

(57) ABSTRACT

Systems for providing secure exchange of authentication and authorization information between a communications device and a backend device and/or application are provided. A forwarding device is positioned between the communications device and the backend device and/or application. The forwarding device is configured to forward information from the communications device to the backend device and/or application. A conversion module is coupled to the forwarding device and is configured to modify the information such that the modified information can be forwarded from the communications device to the backend device and/or application without provision of sign on information by a user. Related methods and computer program products are also provided.

### CROSS REFERENCE TO RELATED APPLICATION

This Application is related to and claims the priority from U.S. Provisional Patent Application Ser. No. 60/717,272, filed Sep. 15, 2005, entitled Single Sign On Authentication Across Devices and Applications, the disclosure of which is hereby incorporated herein by reference.

### FIELD OF THE INVENTION

The present invention generally relates to the field of communications services and, more particularly, to sign on procedures for communications services.

### BACKGROUND OF THE INVENTION

It is becoming more commonplace for devices to have multiple functionalities, for example, devices may operate as both communications devices as well as information devices. For example, some internet protocol (IP) enabled personal digital assistants (PDAs) may have web browsers, Internet-capable applications and/or softphones running on them.

Unlike web sessions that have single sign on (SSO) applications that typically allow a user to sign on to a web page with username and password once and then allow that web session to continue to other web pages for a predetermined duration, there has traditionally been no such SSO application for other communications, such as a softphone or Session Initiation Protocol (SIP) phone. In other words, there typically is no verification, registration and/or validation from the original SSO to other peripheral devices even though the services of these devices may be associated. Thus, the user must again sign on to each application individually. This may be difficult and time consuming, especially with applications that may not provide a user-friendly interface to enter the sign on information.

Recently, protocols have been developed, for example, a security assertion markup language (SAML) protocol, that may facilitate the secure exchange of authentication and authorization information between devices regardless of their security systems or e-commerce platforms. In other words, SAML is a framework for exchanging authentication and authorization information (sign on information). SAML may standardize the representation of these credentials in an XML format called assertions, enhancing the interoperability between disparate applications. Thus, SAML may provide a method of having a SSO function for devices, such as softphones and/or SIP phones. SAML is discussed in detail at world wide web address ietf.org/internet-drafts/draft-tschofenig-sip-saml-04.txt, the disclosure of which is hereby incorporated herein by reference.

### SUMMARY OF THE INVENTION

Some embodiments of the present invention provide systems for providing secure exchange of authentication and authorization information between a communications device and a backend device and/or application. A forwarding device is positioned between the communications device and the backend device and/or application. The forwarding device is configured to forward information from the communications device to the backend device and/or application. A conversion module is coupled to the forwarding device and is configured to modify the information such that the modified information can be forwarded from the communications device to the backend device and/or application without provision of sign on information by a user.

In further embodiments of the present invention, the backend device and/or application may be, for example, a SIP registrar and/or SIP proxy server. The communications device may be, for example, a softphone and/or a SIP phone.

In still further embodiments of the present invention, the conversion module may be further configured to authenticate and authorize the information without provision of sign on information by the user based on security assertion markup language (SAML) information provided with the information.

In some embodiments of the present invention, two or more devices may be coupled to the forwarding device and configured to communicate with each other. The two or more devices may be configured to communicate with each other without provision of sign on information provided by the user. The two or more devices may be configured to communicate with each other without provision of sign on information using security assertion markup language (SAML) information provided with the information.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE FIGURES

Other features of the present invention will be more readily understood from the following detailed description of exemplary embodiments thereof when read in conjunction with the accompanying drawings, in which:

FIG. 1 is a block diagram of a data processing system suitable for use in devices according to some embodiments of the present invention.

FIG. 2 is a block diagram of a system including devices and applications according to some embodiments of the present invention.

FIG. 3 is a flowchart illustrating operations for providing single sign on functionality according to some embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or flowchart illustrations of methods, apparatus, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

It will be understood that at least a portion of the communications described herein can be provided according to Session Initiation Protocol (SIP), which is described in more detail in, for example, “Internet Communications Using SIP,” by Henry Sinnreich, ISBN: 0-471-41399-2. Internet Protocol communications are generally described in, for example, “TCP/IP Protocol Suite,” by Behrouz A Forouzan, ISBN: 0-07-119962-4. Moreover, techniques for the creation and operation of virtual communities, is described in, for example, “Design for Community: The Art of Connecting Real People in Virtual Places,” by Derek M. Powazek, ISBN: 0-7357-1075-9. The content these references is incorporated herein by reference.

The communications discussed herein may be provided using an Internet Protocol (IP) Multimedia Subsystem (IMS). IMS can utilize a packet switched domain (such as the Internet) to transport multimedia signaling and bearer traffic. For example, a Universal Mobile Telecommunication System (UMTS) may be used to access multimedia services of IMS. IP Multimedia Systems are discussed in each of the following: (1) 3GPP TS 22.228 entitled “Service Requirements for the IP Multimedia Core Network Subsystems”; (2) 3GPP TS 23.228 entitled “IP Multimedia Subsystems”; and (3) 3GPP TR 22.941 entitled “IP Based Multimedia Services Framework.” The subject matter of each of these references is hereby incorporated by reference.

It will be understood that communications between devices and applications can be provided via a TCP/IP Session Initiation Protocol (SIP) message, a SS7 (Signaling System 7) message, a common channel signaling message, an in-band signaling message, and/or a Short Message Service (SMS) message, an Enhanced Message Service (EMS) message, a Multimedia Message Service (MMS) message, and/or Smartmessaging™ message. As is known to those skilled in the art, SMS and EMS messages can be transmitted on digital networks, such as GSM networks, allowing relatively small text messages (for example, 160 characters in size) to be sent and received via a network operator's message center to the user device, or via the Internet, using a so-called SMS (or EMS) “gateway.”

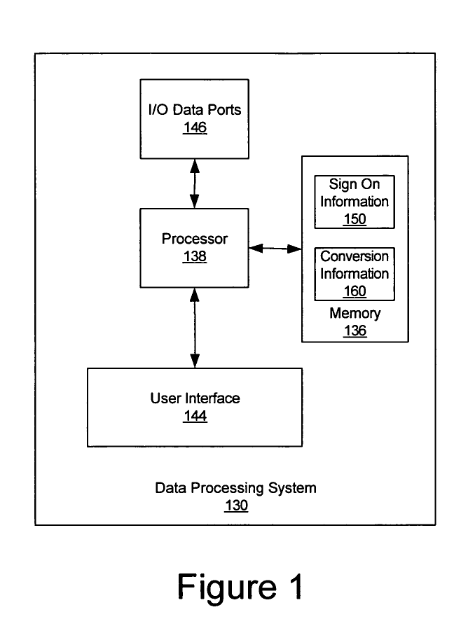

Some embodiments of the present invention will now be discussed with respect FIGS. 1 through 3. As discussed above, communication using devices, such as softphones and session initiation protocol (SIP) phones, typically do not allow verification, registration or validation that occurred during a sign on process of one device to be used for a sign on process of a second device, even during the same session. In other words, a user typically has to reenter the sign on information to obtain access to the second device, which can be time consuming and tedious.

Security Assertion Markup Language (SAML) may be used in combination with SIP to standardize the representation of the sign on information in an XML format called assertions, which may enhance the interoperability between disparate applications/devices. Thus, SAML may provide methods of moving between devices and/or applications without having to reenter the sign on information each time. However, many of the backend devices and/or applications may not be configured to handle SAML. Accordingly, even if SAML is implemented, sign on information may have to be reentered for backend devices and/or applications that are not configured to handle SAML.

It will be understood that although embodiments of the present invention are discussed herein with respect to SAML embodiments of the present invention are not limited to SAML. Other protocols that may facilitate the secure exchange of authentication and authorization information between devices regardless of their security systems or e-commerce platforms may be used without departing from the scope of the present invention.

According to some embodiments of the present invention, a forwarding device is positioned between a communications device, such as a SIP phone, and a backend device and/or application, such as a server. The forwarding device is configured to forward information from the communications device to the backend device and/or application. A conversion module is coupled to the forwarding device and is configured to modify the information being forwarded so that the modified information can be forwarded from the communications device to the backend device and/or application without provision of sign on information by a user. Thus, according to some embodiments of the present invention, a user may sign in once in one device and communicate with other devices and/or other applications that are associated with a common service for the session, i.e., the single sign on (SSO) session may be pervasive throughout all associated applications and devices until the user signs out (terminates the session). In other words, according to some embodiments of the present invention the conversion module may reformat the SAML information so that it is recognizable by the backend device and/or application so that the sign on information does not have to be reentered by the user as will be discussed further below with respect to FIGS. 1 through 3.

SIP will be briefly discussed herein. However, details with respect to SIP are discussed in Internet Communications Using SIP, by Henry Sinnreich, ISBN: 0-471-41399-2, the disclosure of which is incorporated herein by reference as if set forth in its entirety.

There are many Internet applications that create and manage a session. As used herein, a session refers to an exchange of data between an association of participants. The implementation of these applications may be complicated by the practices of participants, for example, users may move between endpoints, users may be addressable by multiple names, and users may communicate in several different media, sometimes simultaneously.

Numerous protocols have been authored that carry various forms of real-time multimedia session data, such as voice, video, or text messages. SIP works in concert with these protocols by enabling Internet endpoints (user agents) to discover one another and to agree on a characterization of a session they would like to share.

For locating prospective session participants, and for other functions, SIP enables the creation of an infrastructure of network hosts (proxy servers) to which user agents can send registrations, invitations to sessions, and other requests. SIP is an agile, general-purpose tool for creating, modifying, and terminating sessions that works independently of underlying transport protocols and without dependency on the type of session that is being established.

SIP supports five facets of establishing and terminating multimedia communications. These facets are user location: determination of the end system to be used for communication; user availability: determination of the willingness of the called party to engage in communications; user capabilities: determination of the media and media parameters to be used; session setup: “ringing”, establishment of session parameters at both called and calling party; and session management: including transfer and termination of sessions, modifying session parameters, and invoking services.

The nature of the services provided may make security particularly important. To that end, SIP provides a suite of security services, which include denial-of-service prevention, authentication (both user to user and proxy to user), integrity protection, and encryption and privacy services.

In particular, SIP is an application-layer control protocol that can establish, modify, and terminate multimedia sessions (conferences), such as Internet telephony calls. SIP can also invite participants to already existing sessions, such as multicast conferences. Media can be added to, and removed from, an existing session. SIP transparently supports name mapping and redirection services, which supports personal mobility. Applications in which SIP can be used include, but are not limited to WIFI phones VoWLAN, wireless GPRS EDGE systems, personal communications; wideband IP telephony, audio and video conferencing and wideband IP telephony.

SAML is a framework for exchanging authentication and authorization information. Security typically involves checking the credentials presented by a party for authentication and authorization. SAML standardizes the representation of these credentials in an XML format called assertions, enhancing the interoperability between disparate applications. In other words, a “cookie” is exchanged between applications and/or devices that includes information about the user (authentication information). Thus, the applications and devices being accessed can authorize and/or authenticate the user based on information in the cookie and, therefore, the user does not have to sign on each time a new application and/or device is accessed. Details with respect to SIP and SAML are known to those having skill in the art and, therefore, will not be discussed further herein.

Referring now to FIG. 1, an exemplary embodiment of a data processing system 130 that may be included in devices, for example, a softphone, SIP phone or backend device, in accordance with some embodiments of the present invention will be discussed. The data processing system 130, may include a user interface 144, including, for example, input device(s) such as a keyboard or keypad, a display, a speaker and/or microphone, and a memory 136 that communicates with a processor 138. The data processing system 130 may further include an I/O data port(s) 146 that also communicates with the processor 138. The I/0 data ports 146 can be used to transfer information between the data processing system 130 and another computer system or a network that may be associated with a communications service provider or user communication devices using, for example, an Internet Protocol (IP) connection. These components may be conventional components such as those used in many conventional data processing systems, which may be configured to operate as described herein. As shown in the embodiments of FIG. 1, the memory 136 includes sign on information 150 and conversion information 160. The elements shown in the memory 136 are provided for exemplary purposes only and, therefore, embodiments of the present invention are not limited to the elements illustrated therein.

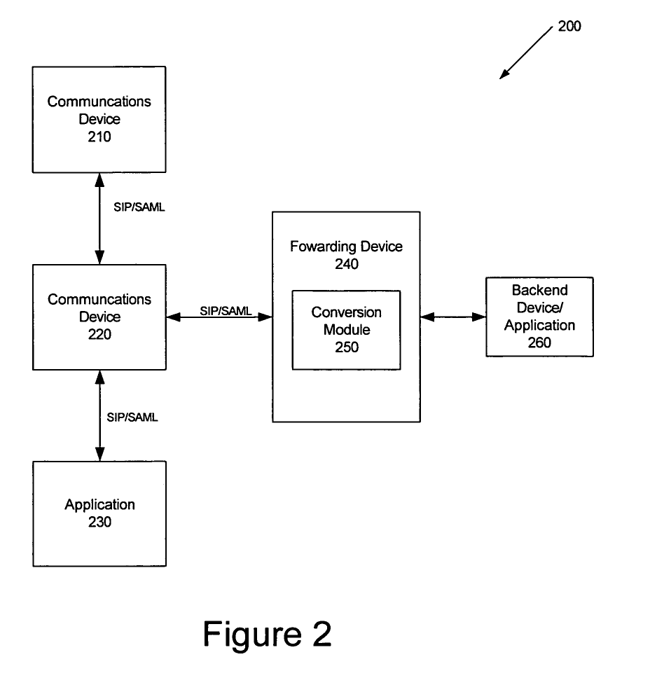

Referring now to FIG. 2, a system 200 including devices and modules according to some embodiments of the present invention will be discussed. The system 200 includes first and second communications devices 210 and 220, a forwarding device 240 including a conversion module 250, a backend device and/or application 260 and an application 230. The data processing system 130 of FIG. 1 may be included in the first and second communications devices 210 and 220, the forwarding device 240 including a conversion module 250 or the backend device 260. Furthermore, the backend application 260 and/or application 230 may run on the data processing system 130. Although the conversion module 250 is illustrated as being disposed in the forwarding device 240, it will be understood that embodiments of the present invention are not limited to this configuration. For example, the conversion module 250 could be a stand-alone module positioned between the forwarding device 240 and the backend device 260 without departing from the scope of the present invention.

Furthermore, it will be understood that although the forwarding device 240 is illustrated as only being coupled to a single communications device 220, embodiments of the present invention are not limited to this configuration. For example, two or more communications device may be coupled to the forwarding device 240 without departing from the scope of the present invention.

The first and second communications devices 210 and 220 may be, for example, softphones or SIP phones without departing from the present invention. Furthermore, the backend devices and/or applications may be, for example, a server, a SIP registrar, SIP proxy server, router or the like.

As discussed above, SAML may be used in combination with SIP to allow a user to move in between devices and/or applications as illustrated in FIG. 2. The forwarding device 240 is configured to forward information, for example, requests, between the communications device 220 and the backend device and/or application 260. However, if the backend device 260 is not configured to handle SAML, the user may have to provide sign on information before the backend device 260 can be accessed. Thus, according to some embodiments of the present invention, a conversion module 250 is provided that is coupled to the forwarding device 240. The conversion module 250 may be configured to process/modify the information received from the communications device that is in a SIP/SAML format and format the information for the backend device 260, such that the modified information can be forwarded from the communications device 220 to the backend device and/or application 260 without provision of sign on information by the user.

Thus, according to some embodiments of the present invention, users can create a session by signing on to a device once and then move between applications without having to provide sign on information each time devices and/or applications are accessed. Accordingly, the use of multiple devices and applications may be simplified and streamlined according to some embodiments of the present invention.

It will be understood that according to some embodiments of the present invention the conversion module 250 may be configured to authenticate and authorize the information without provision of sign on information by the user based SAML information provided with the information. As discussed above, SAML may provide a “cookie” including, but not limited to, the user's sign on information, authentication codes and the like. This cookie may be sent with information that is communicated between devices and/or applications according to some embodiments of the present invention. The information provided in the cookie may be used by the conversion module 250 to allow access to the backend devices and/or applications 260 without provision of sign on information.

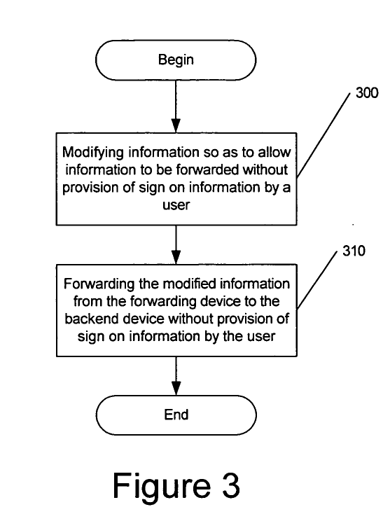

Operations according to some embodiments of the present invention will now be discussed with respect to the flowchart of FIG. 3. Methods according to some embodiments of the present invention are provided for secure exchange of authentication and authorization information between a communications device and a backend device and/or application in a system. The system includes a forwarding device positioned between the communications device and the backend device and/or application and a conversion module coupled to the forwarding device. Information received from a communications device is forwarded from the communications device to a forwarding device. The communications device may be, for example, a SIP phone. At the forwarding device, the information may be modified such that the modified information can be forwarded from the communications device to the backend device and/or application without provision of sign on information by a user (300). The backend device may be, for example, a server or router. Modifying according to some embodiments of the present invention may include authenticating and authorizing the information before forwarding it to the backend device. For example, a SAML cookie may be provided with the information from the communications device. The SAML cookie may include, among other things, information associated with the user, sign on information, authorization codes and the like. This information may be processed/modified and provided to the backend device in a format understandable to the device so as to allow access to the backend device without provision of sign on information. Once modified, the modified information may be forwarded to the backend device and/or application without provision of sign on information by the user (310).

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A system for providing secure exchange of authentication and authorization information between a communications device and a backend device and/or application, comprising:
a forwarding device positioned between the communications device and the backend device and/or application, the forwarding device being configured to forward information from the communications device to the backend device and/or application; and
a conversion module coupled to the forwarding device and configured to modify the information such that the modified information can be forwarded from the communications device to the backend device and/or application without provision of sign on information by a user.

2. The system of claim 1, wherein the backend device and/or application comprises a router, a SIP registrar and/or SIP proxy server.

3. The system of claim 1, wherein the communications device comprises a softphone and/or a SIP phone.

4. The system of claim 1, wherein the conversion module is further configured to authenticate and authorize the information without provision of sign on information by the user based on security assertion markup language (SAML) information provided with the information.

5. The system of claim 1, further comprising two or more devices coupled to the forwarding device and configured to communicate with each other, the two or more devices being configured to communicate with each other without provision of sign on information provided by the user.

6. The system of claim 5, wherein the two or more devices are configured to communicate with each other without provision of sign on information using security assertion markup language (SAML) information provided with the information.

7. A computer implemented method for providing secure exchange of authentication and authorization information between a communications device and a backend device and/or application in a system including a forwarding device positioned between the communications device and the backend device and/or application and a conversion module coupled to the forwarding device, the method comprising:
modifying information forwarded from the communications device to the forwarding device such that the modified information can be forwarded from the forwarding device to the backend device and/or application without provision of sign on information by a user.

8. The method of claim 7, wherein the backend device and/or application comprises a router, a SIP registrar and/or SIP proxy server.

9. The method of claim 7, wherein the communications device comprises a softphone and/or a SIP phone.

10. The method of claim 7, wherein modifying further comprises:
authenticating and authorizing the information, at the conversion module, without provision of sign on information by the user based on security assertion markup language (SAML) information provided with the information.

11. The method of claim 7, further comprising:
communicating information between two or more devices coupled to the forwarding device, the two or more devices being configured to communicate with each other without provision of sign on information provided by the user.

12. The method of claim 11, wherein communicating information comprises communicating information without provision of sign on information using security assertion markup language (SAML) information provided with the information.

13. A computer program product for providing secure exchange of authentication and authorization information between a communications device and a backend device and/or application in a system including a forwarding device positioned between the communications device and the backend device and/or application and a conversion module coupled to the forwarding device, the computer program product comprising:
computer readable storage medium having computer readable program code embodied in said medium, the computer readable program code comprising:
computer readable program code configured to modify information forwarded from the communications device to the forwarding device such that the modified information can be forwarded from the forwarding device to the backend device and/or application without provision of sign on information by a user.

14. The computer program product of claim 13, wherein the backend device and/or application comprises a router, a SIP registrar and/or SIP proxy server.

15. The computer program product of claim 13, wherein the communications device comprises a softphone and/or a SIP phone.

16. The computer program product of claim 13, wherein the computer readable program code configured to modify further comprises:
computer readable program code configured to authenticate and authorize the information, at the conversion module, without provision of sign on information by the user based on security assertion markup language (SAML) information provided with the information.

17. The computer program product of claim 13, further comprising:
computer readable program code configured to communicate information between two or more devices coupled to the forwarding device, the two or more devices being configured to communicate with each other without provision of sign on information provided by the user.

18. The computer program product of claim 17, wherein the computer readable program code configured to communicate information comprises computer readable program code configured to communicate information without provision of sign on information using security assertion markup language (SAML) information provided with the information.
